(19) United States
(12) Patent Application Publication
(10) Pub. No.: US 2015/0257204 A1
(43) Pub. Date: Sep. 10, 2015

(54) ELECTRIC HEATER SAFETY APPARATUS

(71) Applicant: PELEG COHEN, JERUSALEM (IL)

(72) Inventor: PELEG COHEN, JERUSALEM (IL)

(21) Appl. No.: 14/634,913

(22) Filed: Mar. 2, 2015

(30) Foreign Application Priority Data
Mar. 5, 2014 (IL) 231335

(51) Int. Cl. H05B 1/02; F24H 9/20

(52) U.S. Cl. CPC H05B 1/0275; F24H 9/2071

(57) ABSTRACT

An apparatus for disconnecting an alternating current (AC) power to an electrical space heater is disclosed. The apparatus includes a detection module for transmitting a transmission signal over a wireless medium to an electronic module, and an electronic module for receiving the transmission signal. The electronic module disconnects the AC power to the heater upon detecting a change in the transmission signal.

### CROSS-REFERENCE TO RELATED APPLICATIONS

This application claims priority from Israel Patent Application No. 231,335, filed Mar. 5, 2014, the contents of which are incorporated herein by reference in their entirety.

### FIELD OF THE INVENTION

The present invention relates to the field of electrical safety devices. More particularly, the invention relates to a method and apparatus for interrupting electric power supply in heat producing devices.

### BACKGROUND OF THE INVENTION

Space heaters are frequently employed to heat small enclosed areas within a larger premise, for example, to heat individual rooms inside a house. They generally may either use electricity or gas as the source for generating heat.

Space heaters are generally of two types, convection heaters and radiation heaters. Convection heaters generally warm the air directly or warm up a liquid or other suitable fluid which in turn transfers the heat into the air, warming up the air in the enclosed area which in turn may warm up the people in the enclosed area. Radiation heaters, in contrast with convection heaters, do not heat up the air in the enclosed area rather radiate energy into the enclosed area which may be directly absorbed by the people inside, warming them up.

Some convection heaters may use wire elements which are heated up by electricity flowing through the elements, which in turn transfer heat to the air. These types of electric convection heaters may include a fan which may blow the hot air generated by the heat from the electric wire elements for more rapid warming of the enclosed area.

Some radiation heaters may operate by emitting infrared radiation which may be absorbed by people as heat. An example of such a radiation heater is a halogen heater, which may use a quartz tube with a tungsten filament inside through which electricity may flow. Electricity flow through the tungsten filament may cause it to generate heat, which in turn may heat up the quartz tube causing it to radiate infrared waves.

### SUMMARY OF THE INVENTION

There is provided, in accordance with an embodiment of the present invention, an apparatus for disconnecting an alternating current (AC) power to an electrical space heater. The apparatus includes a detection module for transmitting a transmission signal over a wireless medium to an electronic module, and an electronic module for receiving the transmission signal and for disconnecting the AC power to the heater upon detecting a change in the transmission signal.

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a perspective view of an electric heater safety apparatus in use with an electric space heater, according to an exemplary embodiment of the present invention;

FIG. 2 schematically illustrates a perspective view of the apparatus of FIG. 1 in use with the heater, according to an exemplary embodiment of the present invention;

FIG. 3 schematically illustrates a perspective view of an electric heater safety apparatus configured to be used with an existing electric heater, according to an exemplary embodiment of the present invention; and

FIG. 4 schematically illustrates a perspective view of an electric heater safety apparatus with a detection module installed in the housing of an electric space heater, according to an exemplary embodiment of the present invention.

It should be understood that the drawings are not necessarily drawn to scale.

### DETAILED DESCRIPTION OF THE INVENTION

The present invention will be understood from the following detailed description of preferred embodiments, which are meant to be descriptive and not limiting. For the sake of brevity, some well-known features, methods, systems, procedures, components, circuits, and so on, are not described in detail.

Use of electric space heaters, both the convection type and the radiation type, may be accompanied by a risk of fire. In one exemplary scenario, the heater may be inadvertently knocked over and may come in contact with a flammable material, igniting the material. In an attempt reduce the risk of fire, one method includes fitting the heaters with an electric switch which may cut off the AC (alternating current) power to the heater when knocked over. The switch is frequently placed on an underside of the base of the heater so that when the heater is upright the switch is in contact with the floor and in an on position, allowing electricity flow to the heater. When knocked over, contact with the floor is broken and the switch goes into an off position, preventing electricity flow to the heater.

In another exemplary scenario, the heater may be inadvertently covered by a flammable material, for example a blanket, which may interrupt air flow through the heater. As a result, the blanket may be ignited by a build-up of heat generated by the heating elements in the heater. In some cases the blanket may even come into direct contact with the heating elements which may cause the blanket to ignite. In other cases, the blanket may interrupt air flow from a fan in the heater which may cause the fan to overheat, possibly resulting in a short circuit in the fan and again, risk of fire. In this scenario, the electric switch previously described which may be used to interrupt the AC power when the heater is knocked over may prove ineffective. In an attempt to reduce the risk of fire, another method includes fitting the heaters with a thermal cut-off which may cut off the AC power to the heater when a sensed temperature in the heater reaches a certain threshold.

The Applicant has realized that there are a number of disadvantages associated with the above-described methods to reduce the risk of fire. For example, placing the switch on an underside of the base of the heater may cause the heater to be unstable and easily knocked over. Additionally, use of the thermal cut-off may require that the component cut off the AC power to the heater at a lower temperature than that which the heater is designed to operate as a material placed over the heater may ignite at the lower temperature.

The Applicant has further realized that the disadvantages associated with one or more of the above methods, and other methods known in the art, may be overcome by means of an apparatus configured to monitor an upright position of the heater and/or to monitor that the heater is uncovered. Such an apparatus, responsive to a change in any of these conditions in the heater, may be configured to disconnect AC power to the heater.

According to an embodiment of the present invention, the apparatus may include a detection module including a transmitting unit on the heater, and an electronic module including a receiving unit to receive transmissions over a wireless medium from the transmitting unit. The electronic module may additionally include a switching mechanism for disconnecting AC power to the heater responsive to signaling from the receiving unit based on the transmissions received from the transmitting unit.

According to an embodiment of the present invention, communications between the transmitting unit and the receiving unit may include line-of-sight (LOS) communications, where the receiving unit may signal the switching mechanism to disconnect power when the LOS communications between the units is broken. Additionally or alternatively, the receiving unit may signal the switching mechanism to disconnect power responsive to attenuation in the strength of the received transmissions below a predetermined reception level. Loss of LOS communications and or attenuation of the received transmissions may occur, for example, when the heater is knocked over or the transmitting unit is covered by a blanket (blanket placed on the heater).

According to an embodiment of the invention, the detection unit may include a smoke detector which may detect smoke as a result of the heater igniting a flammable material either as a result of being knocked down or of being covered. Responsive to detection of smoke, the smoke detector may signal the transmitting unit to interrupt transmissions to the receiving unit (may send an interruption signal to the transmitting unit), which may cause the receiving unit to signal the switching mechanism to disconnect AC power to the heater. Alternatively, the smoke detector may signal the transmitting unit to transmit a command to the receiving unit to disconnect the AC power to the heater. For example, the transmitting unit may transmit a command signal in the form of an attenuated signal below the predetermined reception level (a cutoff signal), or may transmit a signal specifically identifiable with smoke detection (smoke detection signal).

According to an embodiment of the present invention, the apparatus may be part of a heater, with the detection module integrally attached to the heater during the manufacture of the heater. Alternatively, the apparatus may be used with an existing heater as part of a retrofit kit, and may be suitable for retrofitting onto any type of electric space heater.

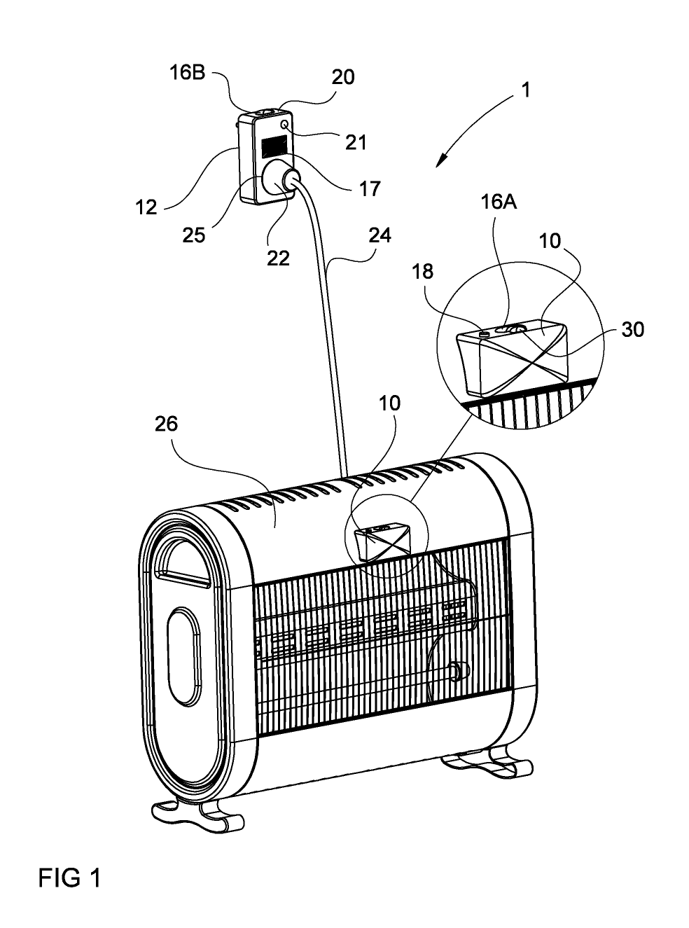

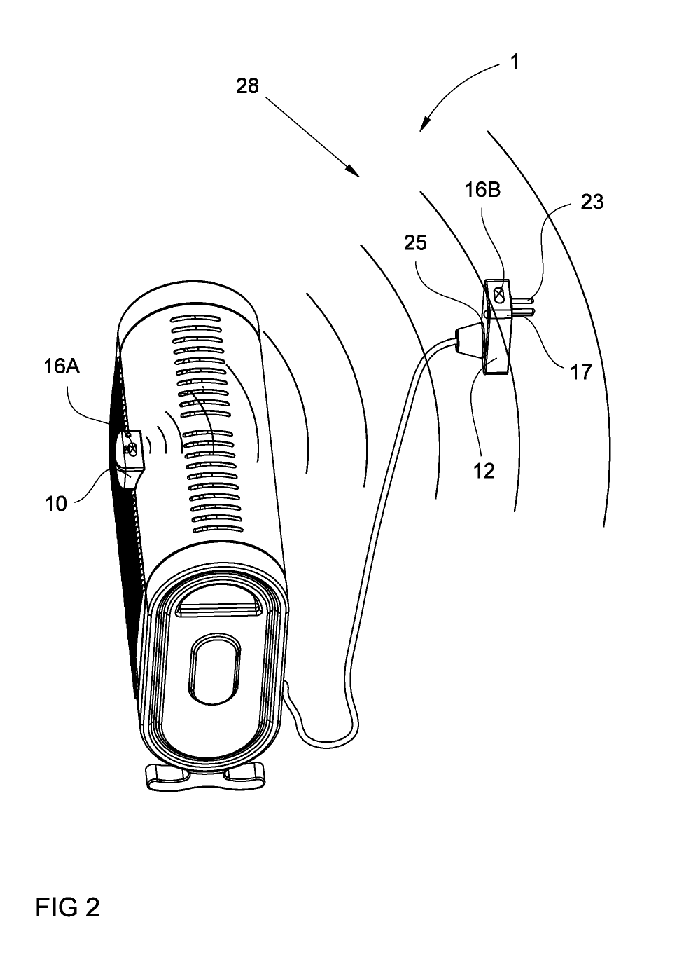

Reference is now made to FIG. 1 which schematically illustrates a perspective view of an electric heater safety apparatus 1 in use with an electric space heater 26, according to an exemplary embodiment of the present invention. Safety apparatus 1 may include a detection module 10 on heater 26 and an electronic module 12. Safety apparatus 1 may be configured to disconnect AC power supply to heater 26 upon the heater being knocked over and/or upon placing of a blanket or other material over the heater which may involve a risk of fire. Reference is also made to FIG. 2 which schematically illustrates a perspective view of apparatus 1 in use with heater 26, according to an exemplary embodiment of the present invention.

Detection module 10 may include a transmitting unit 16a, a built-in-test (BIT) activation switch 18, and a smoke detector 30. Transmitting unit 16a may send transmission signals 28 over a wireless medium, and which may include any one of a laser transmission, an infrared transmission, a radio frequency transmission, a light or other type of optical wave transmission, or other types of wireless transmissions known in the art, or any combination thereof. BIT mechanism 18 may include built-in-test circuitry and firmware which may serve to check the operational status of detection module 10, optionally also electronic module 12, and may include means to visually and/or audibly indicate correct operation and/or faulty operation of the detection module (optionally, the electronic module). Smoke detector 30 may include an infrared detector, a photoelectric detector, or other type of suitable smoke detector known in the art, for detecting smoke which may be produced as a result of heater 26 igniting a flammable material due to the heater being knocked down, or covered by a flammable material while upright, or which may otherwise result from heater operation.

Electronic module 12 may include a receiving unit 16b, an AC power switching mechanism 17, a warning indicator 20, a BIT mechanism 21, an electronic module plug 23, and a heater power cord receptacle 25. Receiving unit 16b may receive transmission signals 28 and may process the received signals to determine if to activate AC power switching mechanism 17 to cut AC power to heater 26.

According to some embodiments, receiving unit 16b may send an activation signal to power switching mechanism 17 if communications with transmitting unit 16a is lost and transmission signal 28 is not received by the receiving unit. Additionally or alternatively, receiving unit 16b may send the activation signal if a power in received transmission signal 28 is below a predetermined reception threshold. Additionally or alternatively, receiving unit 16b may send the activation signal responsive to receiving a command from transmitting unit 16a in transmission signal 28, for example, responsive to detection of smoke by smoke detector 30.

According to an embodiment of the present invention, AC power switching mechanism 17 may include electronic switching circuitry and/or electromechanical switching circuitry for disconnecting AC power supply to heater 26, responsive to receiving the activation signal from receiving unit 16b. Electronic module plug 23 may connect electronic module 12 to an AC power line from which AC power may be supplied through the electronic module to heater 26. Heater 26 may be connected to the electronic module through receptacle 25 which may accommodate heater power cord plug 22 attached to heater power cord 24. Electronic module receptacle 25 and electronic module plug 23 may be electrically disconnected by AC power switching mechanism 17 responsive to the activation signal, disconnecting AC power to heater 26.

Warning indicator 20 may include a visible and/or audible warning mechanism which may serve to alert a user of heater 26 that the heater has been knocked down, that the heater has been covered, or of the presence of smoke, or any combination thereof. BIT mechanism 21 may include built-in-test circuitry and firmware which may serve to check the operational status of electronic module 12, optionally also detection module 10, and may include means to visually and/or audibly indicate correct operation and/or faulty operation of the electronic module (optionally, the detection module).

Detection module 10 and electronic module 12 may communicate over the wireless medium, transmitting unit 16a sending transmission signals 28 to receiving unit 16b. Transmission signals 28 may be continuously transmitted by transmitting unit 16a, or alternatively may be intermittently transmitted which may include periodic transmissions at predetermined time intervals, for example, every 0.1 seconds, 0.5 seconds, 1 seconds, 5 seconds, 10 seconds, or more or less. Communications between transmitting unit 16a and receiving unit 16b may include LOS communications, that is, the units may have to be in sight of one another in order for the receiving unit to receive transmission signals 28. Alternatively, transmission signals 28 received by receiving unit 16b may be attenuated when the receiving unit is not in LOS with transmitting unit 16a.

In an exemplary mode of operation, when heater 26 is upright and/or not covered by a blanket, transmitting unit 16a and receiving unit 16b are in LOS and transmission signals 28 are received by the receiving unit. Receiving unit 16b does not generate the activation signal so the AC power supply mechanism 17 maintains an electrical connection between electronic module plug 23 and electronic module receptacle 25. AC power is provided to heater 26.

In a first exemplary scenario of risk of fire where heater 26 is knocked over, LOS communications may be broken between transmitting unit 16a and receiving unit 16b. Responsively to the breaking of communications, receiving unit 16b may generate the activation signal to power switching mechanism 17 to disconnect power to heater 26. Alternatively, LOS communication may not be broken but the power in the received transmission signals may be attenuated due to the change in the position of the heater from upright to horizontal or tilted. Responsively, receiving unit 16b may generate the activation signal if the received power is below the predetermined reception threshold. Warning indicator 20 may generate a visual and/or audible warning to alert the user of heater 26 having been knocked over or covered by a material.

In a second exemplary scenario of risk of fire where heater 26 is covered by a material, the material may interfere with the LOS communications between transmitting unit 16a and receiving unit 16b. LOS communications may be broken by the interfering material or may cause attenuation of transmission signals 28. Similarly to the first scenario, receiving unit 16b may generate the activation signal to power switching mechanism 17 to disconnect electronic module plug 23 from electronic module receptacle 25, cutting the AC power to heater 26. Warning indicator 20 may generate a visual and/or audible warning to alert the user of heater 26 having been knocked over or covered by a material.

In a third exemplary scenario of risk of fire, smoke detector 30 may provide an additional safety mechanism to the use of transmitting unit 16a and receiving unit 16b. For possible cases where, despite heater 26 being knocked over and/or covered, there is no loss of LOS communication nor attenuation below the predetermined reception level, smoke detector 30 may detect first signs of smoke and may send an interruption signal to transmitting unit 16a to interrupt transmission signal 28, or may send a signal to the transmitting unit to send a cut-off signal or a smoke signal to receiving unit 16b. Warning indicator 20 may generate a visual and/or audible warning to alert the user of heater 26 of smoke detection.

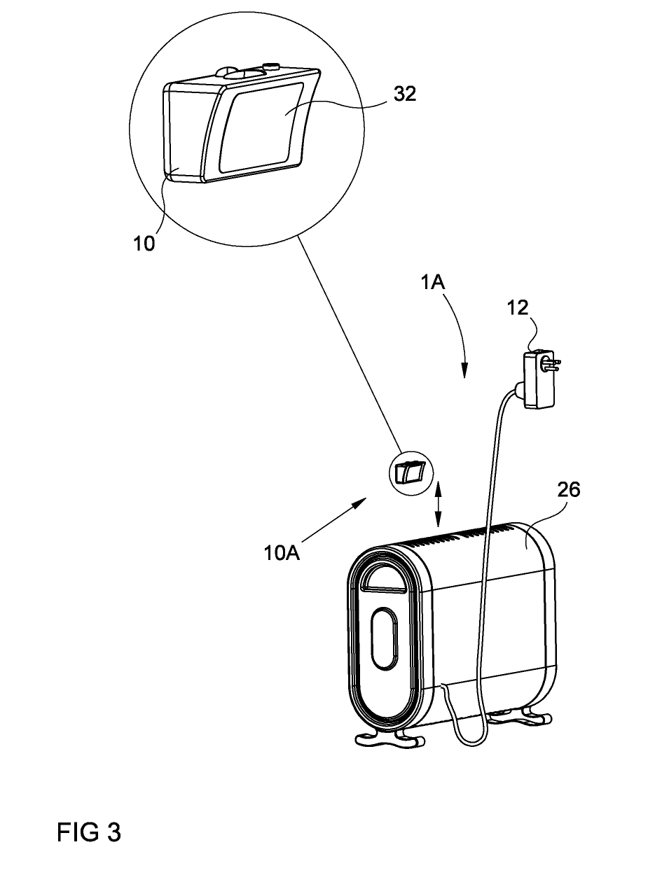

Reference is now made to FIG. 3 which schematically illustrates a perspective view of an electric heater safety apparatus 1A configured to be used with an existing electric heater 26, according to an exemplary embodiment of the present invention. Apparatus 1A may include detection module 10 and electronic module 12, and may be functionally similar to apparatus 1 previously described.

Detection module 10 includes an attachment mechanism 32 for attaching the detection module to heater 26. Attachment mechanism 32 may include an adhesive fastener such as a glue, a double-sided adhesive paper, a hook and fastener mechanism (Velcro™) with one side of the fastener mechanism adhered to detection module 10 and the other side adhered to heater 26, among other possible mechanical fastening means and attachment mechanisms known in the art.

Apparatus 1A may be part of a retrofit kit including any one of detection module 10 and electronic module 12. Additionally included in the retrofit kit may be attachment mechanism 32 as part of detection module 10A, or as a separate component which may be attached to detection module 10.

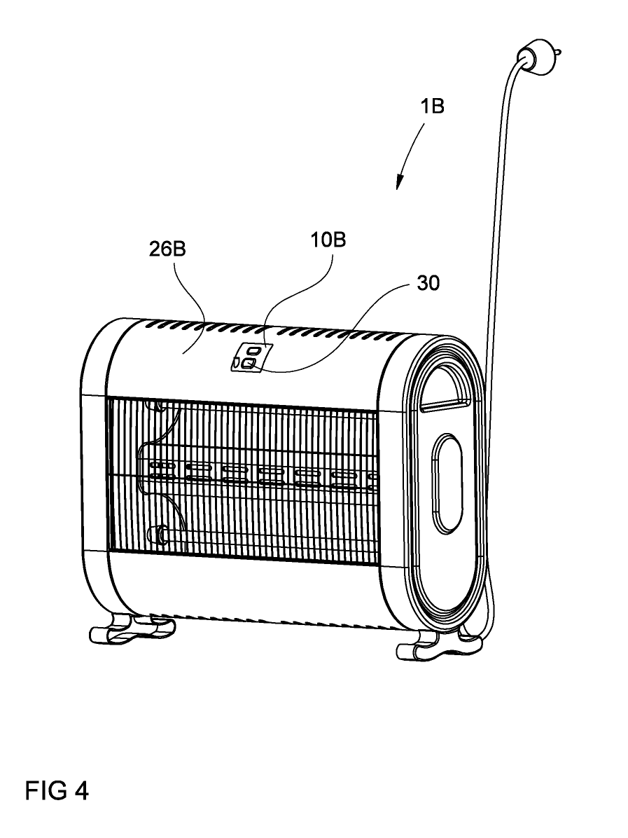

Reference is now made to FIG. 4 which schematically illustrates a perspective view of an electric heater safety apparatus 1B with a detection module 10B installed in the housing of an electric space heater 26B, according to an exemplary embodiment of the present invention. Apparatus 1B may include a detection module 10B functionally similar to detection module 10 in apparatus 1 with the exception that detection module 10B is built into electric heater 26B, and an electronic module 12. Apparatus 1B may be functionally similar to apparatus 1 and 1A previously described.

Detection module 10B may be installed onto a housing of heater 26B during manufacture of the heater. Alternatively, detection module 10B may be installed onto the housing following manufacture of heater 26B, for example, as a retrofit procedure on heater 26 in the previous figures. In this type of retrofitting, a cutout may be made on the housing of heater 26 for accommodating detection module 10B.

Thus, there is provided, in accordance with an embodiment of the present invention, an apparatus (1) for disconnecting an alternating current (AC) power to an electrical space heater (26). The apparatus (1) includes a detection module (10) for transmitting a transmission signal (28) over a wireless medium to an electronic module (12), and an electronic module (12) for receiving the transmission signal (28) and for disconnecting the AC power to the heater (26) upon detecting a change in the transmission signal (28).

According to an embodiment of the present invention, the transmission signal (28) is any one of a laser signal, a radio frequency signal, an infrared signal, and a light signal.

According to an embodiment of the present invention, the detection module (10) includes a transmitting unit (16a) to transmit the transmission signal (28).

According to an embodiment of the present invention, the detection module (10) includes a smoke detector (30).

According to an embodiment of the present invention, the smoke detector (30) includes any one of an infrared detector and a photoelectric detector.

According to an embodiment of the present invention, the electronic module (12) includes a receiving unit (16b) for receiving the transmission signals (28).

According to an embodiment of the present invention, the electronic module (12) includes a power switching mechanism (17) to disconnect AC power supply to the heater (26) responsive to signaling from the receiving unit (16b).

According to an embodiment of the present invention, the electronic module (12) includes a plug (23) for connecting the electronic module (12) to the AC power line.

According to an embodiment of the present invention, the electronic module (12) includes a receptacle (25) for mating with an AC power cord plug (22) of the heater (26).

According to an embodiment of the present invention, the apparatus (1) additionally includes an attachment mechanism (32) for attaching the detection module (10) to the heater (26).

In the figures and/or description herein, the following reference numerals have been mentioned:

| | Reference |
|---|---|
| Part Identification | No. |
| Electric Heater Safety Apparatus | 1 |
| Electric Heater Safety Apparatus | 1A |
| Electric Heater Safety Apparatus | 1B |
| Detection Module | 10 |
| Detection Module | 10A |
| Detection Module | 10B |
| Electronic Module | 12 |
| Transmitting Unit | 16a |
| Receiving Unit | 16b |
| AC Power Switching Mechanism | 17 |
| BIT (Built-in-test) Mechanism | 18 |
| Warning Indicator | 20 |
| BIT Mechanism | 21 |
| Heater Power Cord Plug | 22 |
| Electronic Module Plug | 23 |
| Heater Power Cord | 24 |
| Electronic Module Power Cord Receptacle | 25 |
| Electric Space Heater | 26 |
| Electric Space Heater | 26B |
| Transmission Signal | 28 |
| Smoke Detector | 30 |
| Attachment Mechanism | 32 |

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An apparatus for disconnecting an alternating current (AC) power to an electrical space heater comprising:
a detection module for transmitting a transmission signal over a wireless medium to an electronic module ; and
an electronic module for receiving said transmission signal and for disconnecting the AC power to the heater upon detecting a change in said transmission signal.

2. An apparatus according to claim 1 wherein said transmission signal is any one of a laser signal, a radio frequency signal, an infrared signal, and a light signal.

3. An apparatus according to claim 1 wherein said detection module comprises a transmitting unit to transmit said transmission signal.

4. An apparatus according to claim 1 wherein said detection module comprises a smoke detector.

5. An apparatus according to claim 4 wherein said smoke detector comprises any one of an infrared detector and a photoelectric detector.

6. An apparatus according to claim 1 wherein said electronic module comprises a receiving unit for receiving said transmission signals.

7. An apparatus according to claim 1 wherein said electronic module comprises a power switching mechanism to disconnect AC power supply to the heater responsive to signaling from said receiving unit.

8. An apparatus according to claim 1 wherein said electronic module comprises a plug for connecting said electronic module to the AC power line.

9. An apparatus according to claim 1 wherein said electronic module comprises a receptacle for mating with an AC power cord plug of the heater.

10. An apparatus according to claim 1, further comprising an attachment mechanism for attaching said detection module to the heater.
